(19) United States
(12) Patent Application Publication
(10) Pub. No.: US 2006/0232672 A1
(43) Pub. Date: Oct. 19, 2006

(54) Overhead display device with dual panel structure for a vehicle

(76) Inventors: Song Sim, Seoul (KR); Seung Il Kim, Seoul (KR)

Correspondence Address: SALTAMAR INNOVATIONS, 30 FERN LANE, SOUTH PORTLAND, ME, 04106, US

(21) Appl. No.: 11/132,477

(22) Filed: May 19, 2005

(30) Foreign Application Priority Data
Apr. 18, 2005 (KR) 10-2005-0031764

(51) Int. Cl. H04N 7/18; H04N 9/47

(52) U.S. Cl. 348/148; 348/143

(57) ABSTRACT

An vehicle ceiling mounted overhead display device comprising a rear facing first display panel providing entertainment image, a rear facing camera for photographing a scene behind the vehicle and outputting the captured image, an image processor for selecting a image region from the captured image, and outputting the selected image region, and a second display panel mounted opposite to the first display panel for providing the selected image region to the driver so that the driver can monitor the image at the rear of the vehicle via a rearview mirror with minimal obstruction caused by the overhead display device body.

### FIELD OF THE INVENTION

The present invention relates to an overhead display device for a vehicle, and more particularly, to an overhead display device with dual panel structure for a vehicle, which avoids obstruction to visibility by a rear view mirror.

### BACKGROUND

Among automotive audio/video electronics, an overhead display device for providing entertainment, such as a television (TV), digital versatile disc (DVD), games, and the like, is on the market. The overhead display device generally comprises a mount, which is mounted onto the ceiling of the vehicle. Generally, the overhead display device is monitored not by the ones seated in the front seats of the vehicle but by passengers seated on the rear seats.

However, the conventional overhead display device presents a problem that the overhead display itself can obstruct rearview mirror of the vehicle. Therefore, oftentimes, the overhead display devices are not available for installation during manufacture of the vehicle, but as an after-market device, due to risks stemming from product liability (PL) considerations.

FIG. 1 shows a structure of general overhead display device, and FIG. 2 is a diagram showing schematically a drawback associated with the conventional overhead display device. As shown in FIG. 1, the conventional overhead display device 10 is mounted on the ceiling between a first row and second row, wherein the first row is generally defined by a driver's seat line and the second row is generally defined by a backseat line. However, as shown in FIG. 2, the conventional overhead display device has a drawback that the body 22 of overhead display can obstruct rearview visibility via the rearview mirror 20 of the vehicle, so that it is of limited use during driving. In order for a user seated in a rear seat to comfortably view the screen, a large screen size is desired, or the screen should be moved to a lower position in the vehicle. However, in that case, the conventional overhead display device further obstructs the rearview mirror field of vision.

### SUMMARY OF THE INVENTION

The present invention provides an overhead display comprising a dual panel structure thereby preventing the overhead display device itself from becoming an obstruction to safe driving by prevention of monitoring behind the vehicle using the rearview mirror.

According to the preferred embodiment, there is provided an overhead display device with a dual panel structure for vehicle, comprising:

a first display panel providing entertainment image which is mounted on the ceiling of a vehicle; a rear facing camera for obtaining rearview image of a scene behind the vehicle and outputting the rearview image; an image processor for selecting a region of the rearview image; and a second display panel facing forwardly and coupled in opposed relationship with the first display panel (i.e. substantially in back to back relationship), for displaying the selected image region to the driver.

In the preferred embodiment of the present invention, the image processor comprises a pan/tilt module for moving the image region to be selected based on pan control of right and left direction and tilt control of upper and lower direction in respond to a user control signal preferably entered via a remote controller; and a zooming module for reducing and/or magnifying the image region to be selected based on user control signal also preferably entered via the remote controller.

Preferably, the remote controller comprises a button portion for inputting control commands from the user and generating control command signals; a modulator for modulating the control command signals induced via operation of the button portion; and an amplifier for amplifying the modulated control command signals, and outputting said remote control signals. In the preferred embodiment, the zoom and/or the tilt/pan portions operate by selecting a region of a larger scene captured by the camera. However the camera itself may be coupled to a tilt/pan mechanism and the zoom may be obtained optically.

The rear view camera may be integral to the display device or may be mounted separately elsewhere in the vehicle.

### BRIEF DESCRIPTION OF THE DRAWINGS

The above aspects and advantages of the present invention will become more apparent by describing in detail preferred embodiments thereof with reference to the attached drawings in which:

FIG. 1 shows a structure of general overhead display device;

FIG. 2 is a schematic diagram showing a drawback associated with the conventional overhead display device;

FIG. 3 is a block diagram of an overhead display device with dual panel structure for vehicle according to the preferred embodiment of the present invention;

FIG. 4 is a schematic diagram showing operation of the image processor coupled to the overhead display device with dual panel structure of FIG. 3;

FIGS. 5 and 6 are diagrams for demonstrating the effectiveness of the overhead display device with dual panel structure according to the preferred embodiment.

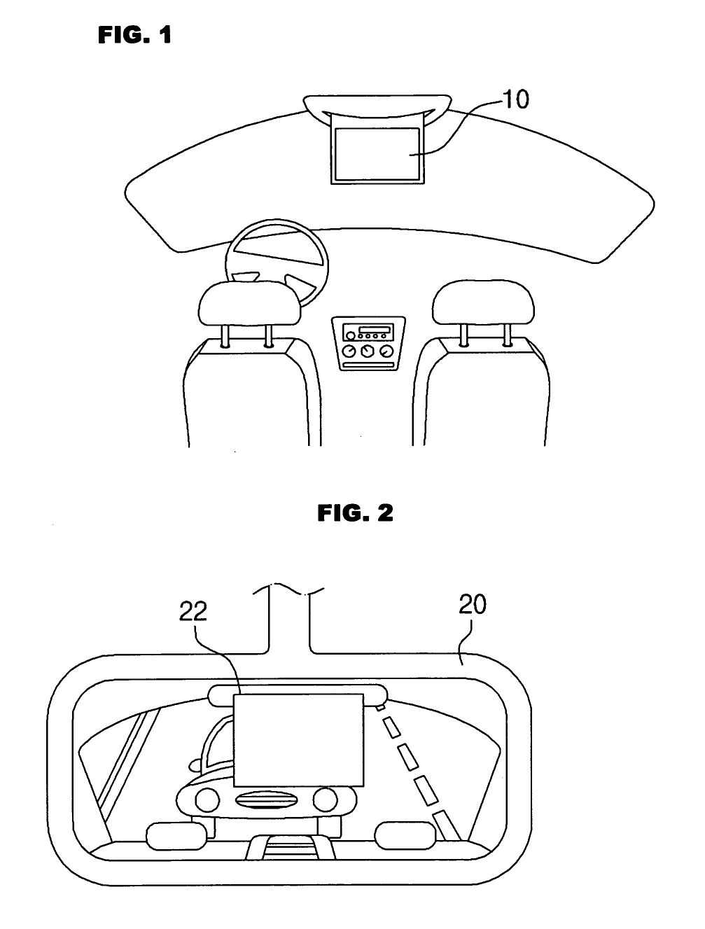

### DETAILED DESCRIPTION OF THE INVENTION

Preferred embodiments of the present invention will now be described in more detail with reference to the accompanying drawings.

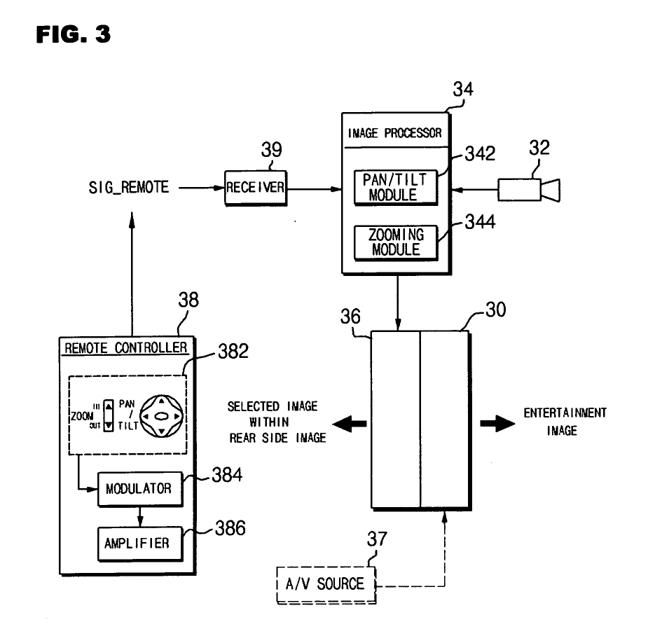

FIG. 3 is a block diagram of an overhead display device with dual panel structure for a vehicle according to the preferred embodiment of the present invention. Referring to FIG. 3, the overhead display device comprises a first display panel 30 capable of providing entertainment image which is mounted to the ceiling of a vehicle, a rear facing camera 32 for photographing the view towards the rear side of the vehicle and outputting the rearview image, an image processor 34 for selecting an image region comprising at least a portion of the region obscured by the body of the overhead display device, out of the rear view image, and outputting the selected image region, and a second, front facing display panel 36 preferably mounted at the back of the first display panel for providing the selected image region to the driver so that the driver can monitor the rear side of the vehicle via a rearview mirror. The entertainment image is provided by any A/V (AudioMsual) source 37, for example, TV tuner (not shown), DVD player (not shown), and PDA (Personal Digital Assistant). The A/V source is shown in dashed line as it is not necessarily a part of the present invention.

The image processor 34 can select the region obscured by the body of the overhead display device out of the rear view image, however, more preferably, can select a specific image region of a somewhat wider region than the obscured region, out of the whole rear view image, and output the selected image region.

In this embodiment, the image processor 34 includes a pan/tilt module 342 and a zooming module 344. The pan/tilt module 342 moves the image region to be selected based on pan control in the right and left directions and tilt control in the up or down directions in response to input by the user, preferably entered via a remote controller 38. The zooming module 344 reduces and/or magnifies the image region to be selected based on user input, preferably also entered by the remote controller. By the above described process, the user can adjust the image on the second display panel 36 to display the obscured region, allowing the driver to see the obscured region in the second display reflected in the rearview mirror.

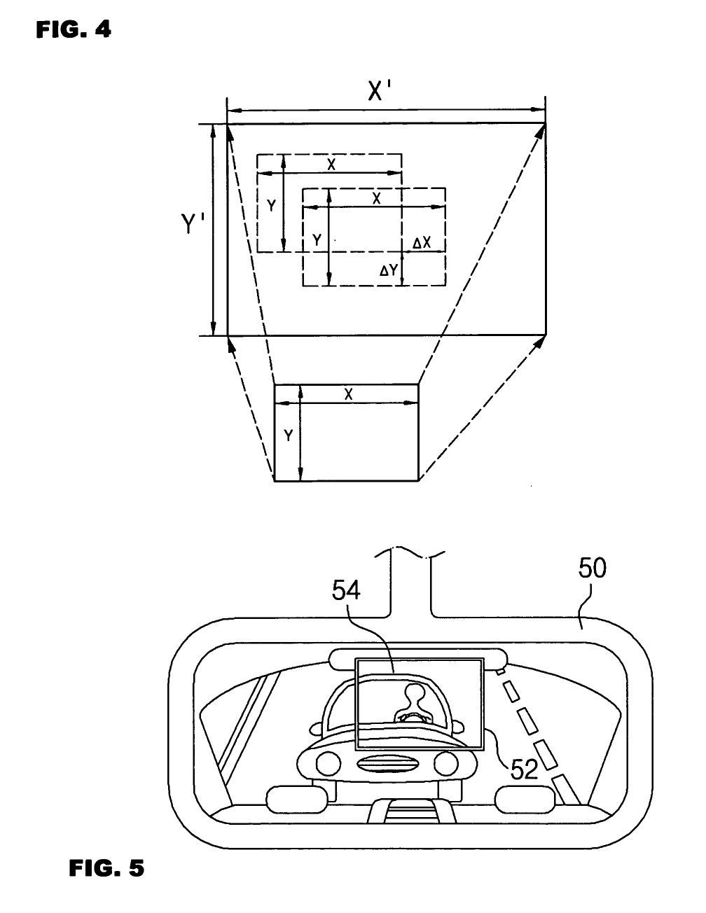

FIG. 4 is a schematic diagram showing the operation of the image processor included in the overhead display device of FIG. 3. Referring to FIG. 4, the image processor 34 selects a region, preferably corresponding to the region obscured by the body of the overhead display device, out of the rear view image captured by the camera 32. For example, corresponding to the region of X wide and Y long, where X and Y represent an image smaller than the image covering the overall rear window size. The pan/tilt module 342 moves the image region to be selected based on pan control of right and left direction and tilt control of upper and lower direction by the amount of ΔX to the crosswise direction and ΔY to the lengthwise direction in response to a user signal entered by a remote controller. The zooming module 344 reduces and/or magnify the image region to be selected based on zooming in and/or zooming out control in response to a user signal entered by a remote controller, to select the image region to be selected to be X′ pixels wide and Y′ pixels tall. The image processor 34 moves the selected image region based on pan control of right and left direction and tilt control of upper and lower direction.

Generally, the angel of the overhead display device can be adjusted according to height and taste of one seated in the rear seats. However, the photographed image can be distorted in crosswise direction approximately 5% of normal size between top portion and bottom portion. Therefore, an image distortion compensating module (not shown) may be further incorporated in the image processor 34 for correcting the distortion of the image.

Also, according to the preferred embodiment, remote controller 38 and receiver 39 is further included. Remote controller 38 includes an adjust button portion 382, a modulator 384, and an amplifier portion 386. The adjust button portion 382 receives control commands from a user and output a control command signals. The modulator 384 modulates the control command signals. The amplifier 386 amplifies the modulated control command signal and outputs the remote control signal SIG_REMOTE. The adjust button portion 382 at least include a button for zoom in/out selection and a button for pan/tilt selection, so that a predetermined control command signal corresponding to the pressed button is output.

Outputting of the remote control signals are preferably based on infra-red light. Thus, a transmitter (not shown) transmits the remote control signal SIG_REMOTE using infra-red light. In this case, the transmitter will preferably be located in the rear portion of the controller body, so that, when the user adjusts the second display panel 36 to display the obscured region while looking at the rear window reflection of the rearview mirror, the remote control signal SIG_REMOTE is received by a receiver 39, such as infra-red light sensor. The receiver 39 and the image processor may be integrated within the display device or mounted separately elsewhere in the vehicle, such as near the rear window.

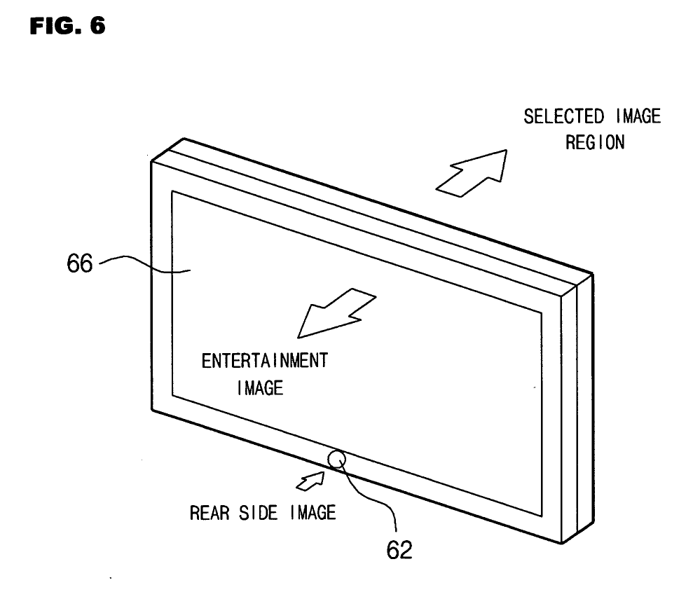

FIGS. 5 and 6 are diagrams for demonstrating the effectiveness of the overhead display device with dual panel structure according to the preferred embodiment of the present invention. Referring to FIG. 5, if the above-described overhead display device is installed, the driver can monitor the region obscured by the body 52 of the overhead display device by viewing the rearview mirror 50, in which the obscured region is displayed by the second display panel 54. Also, referring to FIG. 6, the user seated in a rear seat can enjoy the entertainment image by using of the first display panel 66 which is mounted on the ceiling of a vehicle, and the driver can monitor the image in the rear of the vehicle via the rearview mirror by the second display panel mounted substantially to the back of the first display panel 66. The camera 62 may be mounted in, for example, the lower portion of the first display panel 66, or elsewhere in the vehicle.

Therefore, the vehicle overhead display device with dual panel structure according to the preferred embodiment reduce the rear view obstruction that the overhead display presents while in use, so as to drastically improve safety. Moreover, by mitigating this safety problem the device may be installed during vehicle manufacture, and not only as an aftermarket device.

What is claimed is:

1. An overhead display device with a dual panel structure for ceiling mounting in a vehicle, the device comprising:
a first display panel capable of providing entertainment image; a rear viewing camera for obtaining a rear view image of the field behind the vehicle, and outputting the rear view image;
an image processor capable of selecting an image region from the rear view image and outputting the selected image region; and
a second display panel coupled substantially in opposed relationship with the first display panel for displaying the selected image region to the driver.

2. An overhead display device having a dual panel structure as claimed in claim 1, wherein the image processor comprises:
a pan/tilt module for moving the image region to be selected based on pan control of right and left direction and tilt control of upper and lower direction in respond to a user selection; and
a zooming module for reducing and/or magnifying the image region to be selected based on a user selection.

3. An overhead display device having a dual panel structure as claimed in claim 1, further comprising a remote controller for providing control signals to the display device, and a receiver coupled to the display device.

4. The overhead display device with a dual panel structure of claim 3, wherein the remote controller comprises:
a button portion for inputting control commands from a user and generating a control command signal;
a modulator for modulating the control command signal generated by the button portion; and
an amplifier for amplifying the modulated control command signal and outputting the amplified signal as a remote control signal.

5. An overhead display device having a dual panel structure as claimed in claim 3, wherein the image processor comprises:
a pan/tilt module for moving the image region to be selected based on pan control of right and left direction and tilt control of upper and lower direction in respond to a user selection; and
a zooming module for reducing and/or magnifying the image region to be selected based on a user selection.

6. An overhead display device having a dual panel structure as claimed in claim 1, wherein the rear viewing camera is integral the display device.

7. An overhead display device having a dual panel structure as claimed in claim 1, wherein the rear viewing camera is coupled to the vehicle.

8. An overhead display device having a dual panel structure as claimed in claim 2, wherein the image processor further comprises an image distortion compensation module.

9. An overhead display device with a dual panel structure for ceiling mounting in a vehicle, the device comprising:
a first display panel capable of providing entertainment image; a rear viewing camera for obtaining a rear view image of the field behind the vehicle, and outputting the rear view image;
an image processor capable of selecting an image region from the rear view image and outputting the selected image region, the image processor comprising a pan/tilt module for moving the image region to be selected based on pan control of right and left direction and tilt control of upper and lower direction in respond to a user selection and a zooming module for reducing and/or magnifying the image region to be selected based on a user selection; and
a second display panel coupled substantially in opposed relationship with the first display panel for displaying the selected image region to the driver.

10. An overhead display device having a dual panel structure as claimed in claim 9, wherein the camera is integrated within an enclosure containg the first and second display panels.

11. An overhead display device having a dual panel structure as claimed in claim 9, wherein the camera is mounted to the vehicle.

12. An overhead display device having a dual panel structure as claimed in claim 9, further comprising a remote controller for providing control signals to the display device, and a receiver coupled to the display device.
